(19) United States
(12) Patent Application Publication
(10) Pub. No.: US 2020/0006757 A1
(43) Pub. Date: Jan. 2, 2020

(54) Optimized Lithium Ion Battery Cell

(71) Applicant: K2 Energy Solutions, Inc., Henderson, NV (US)

(72) Inventors: James D. Hodge, Henderson, NV (US); Yan Gong, Henderson, NV (US); Harley D. Hoskins, Henderson, NV (US); Joseph C. Turner, Chattanooga, TN (US)

(21) Appl. No.: 16/454,697

(22) Filed: Jun. 27, 2019

Related U.S. Application Data
(60) Provisional application No. 62/692,923, filed on Jul. 2, 2018.

(51) Int. Cl. H01M 4/36; H01M 10/0525; H01M 4/62

(52) U.S. Cl. CPC H01M 4/362; H01M 4/622; H01M 10/0525

(57) ABSTRACT

An optimized lithium ion battery cell is disclosed. The battery cell comprises an anode and a cathode. The cathode is coated with a cathode coating comprising a cathode mixture of a cathode powder adapted for an energy cell application, a binder, and a conductive agent. The cathode mixture is of a respective ratio of 3 (binder) to 2 (conductive agent) to 95 (cathode powder). The anode is coated with an anode coating comprising an anode mixture of an anode powder adapted for an energy cell application, a first binder, a second binder, and a conductive agent. The anode mixture is of a respective ratio of 1.5 (first binder) to 2 (conductive agent) to 94 (anode powder) to 2.5 (second binder).

### BACKGROUND

Lithium ion cell performance generally falls into two categories. The first category includes what are typically referred to as energy cells, and the second category includes what are typically referred to as power cells. These categories are generally dictated by the performance needed in applications in which they are used.

Energy cells are typically designed to perform at a relatively low discharge rate for a relatively long period of time, i.e., energy density applications. Power cells are typically designed to perform at a relatively high discharge rate for a relatively short period of time, i.e., power density applications. Unfortunately the two cell types may require two manufacturing techniques, and different materials and processes. It may also require time for training of sales staff, customers, and users on what particular type of cell will work best for a particular application.

A cell that will work in either case may simplify such factors as supply chain, manufacturing process, sales, distribution, and the like.

### SUMMARY

In accordance with one aspect of the present invention, an optimized lithium ion battery cell is provided which may satisfactorily perform as both an energy cell and a power cell.

The optimized lithium ion battery cell may perform in applications requiring aspects of both an energy cell and a power cell, such as applications requiring both high energy cell performance, yet also requiring relatively intermittent, short, high power pulses.

A battery pack containing multiple optimized lithium ion battery cells may be smaller, due to being able to satisfy high-power requirement will fewer cells.

The optimized lithium ion battery cell may also open up new applications and customers.

These and other objectives and advantages will become apparent from the following description taken in conjunction with the accompanying drawing wherein are set forth, by way of illustration and example, certain embodiments of the invention.

### DESCRIPTION OF THE FIGURES

FIG. 1 is a Ragone plot of three lithium ion battery cell types, one of a conventional power cell, one of a conventional energy cell, and one of an optimized lithium ion battery cell made in accordance with the present invention; and

FIG. 2 is a cycle graph of three cell types, including an optimized lithium ion cell made in accordance with the present invention.

### DESCRIPTION OF THE PREFERRED EMBODIMENTS

While this invention is susceptible of embodiment in many different forms, there will be described herein in detail, specific embodiments thereof with the understanding that the present disclosure is to be considered exemplifications of the principles of the invention and is not intended to limit the invention to the specific embodiments illustrated.

Table 1, below, describes various characteristics of a typical power cell and a typical energy cell. Shaded entries indicate the characteristics of the optimized lithium ion cell of the present invention.

| | Cell Type | Power Cell | Energy Cell |
|---|---|---|---|
| 1 | Cathode powder | Relatively smaller particle | Relatively larger |
| | | size, relatively greater | particte size, |
| | | particle surface area | relatively lesser |
| | | | particle surface |
| | | | area |
| 2 | Anode powder | Synthetic graphite | Different type of |
| | | | synthetic Graphite |
| 3 | Mixing formula | Less cathode content, | Higher cathode |
| | for cathode | higher conductive agent | content, lower |
| | | content, higher binder | conductive agent |
| | | content | content, lower |
| | | | binder content |
| 4 | Mixing formula | Same as above | Same as above |
| | for anode | | |
| 5 | Coating thickness | Electrode is thinner and | Electrode is thicker |
| | on Cathode | longer | and shorter |
| | electrode | | |
| 6 | Coating thickness | Same as above | Same as above |
| | on Anode | | |
| | electrode | | |
| 7 | Physical Structure | More tabs on electrode | Less tabs on |
| | of electrodes | | electrode |

As is known, a conventional lithium ion cell typically includes a cathode electrode and an anode electrode. The cathode electrode is typically coated with a cathode powder, and the anode electrode is typically coated with an anode powder. There are commercially available cathode and anode coating powders which are provided for power cell applications and cathode and anode coating powders which are provided for energy cell applications. For example:

### Cathode Coating Powders:

| Manufacturer | Power | Energy |
|---|---|---|
| Johnson Matthey Fine Chemicals | P2 | P1 |
| Advanced Lithium Electrochemistry | M13 | M121 |
| Co, Ltd. (Aleees) | | |
| Sumitoma Osaka Cement Co., Ltd | 420B | 420A |
| Tatyng Fine Chemicals | P13f | P14 |

### Anode Coating Powders:

| Manufacturer | Power | Energy |
|---|---|---|
| Osaka Gas Chemical | GramaX | OMAC-R |
| BTR New Energy Material Ltd. | S350 | 319-M |
| Jiangxi Zichen Technology Co, Ltd. | AGT | G1 |

As is known, a conventional lithium ion cell typically includes a typical, respective mixing formula for mixing each of the anode powder and the cathode powder with other materials, such as a conductive agent and a binder agent, for each of respective power cells and for energy cells. For example, component ratios of typical anode and cathode formulas for each of energy cells and power cells may be (unless specifically indicated otherwise, the numeric value for each of the components within the stated ranges herein is +/−0.2):

Energy type cathode formula ratio:

Binder:Conductive agent:Active material»3:2:95;

Energy type anode formula ratio:

Binder A:Conductive agent:Active material:Binder B»1.5:1:95:2.5;

Power type cathode formula ratio:

Binder:Conductive agent:Active material»5.5:6.5:88; and

Power type anode formula ratio:

Binder A:Conductive agent:Active material:Binder B»1.5:2:94:2.5.

In the above examples, Binder A may be a conventional CMC (carboxymethyl cellulose) solution, and Binder B may be conventional styrene-butadiene rubber (SBR), in combination at the appropriate ratios.

As is known, a conventional lithium ion cell may include a typical coating thickness (conventionally referred to as ‘coat weight’) for the anode and the cathode, for each of an energy cell and a power cell. Typical anode and cathode coating thicknesses for each of a conventional energy cell and power cell may be:

Energy type cathode coating thickness: 178 g/m² (+/−3 g/m²);

Energy type anode coating thickness: 94 g/m² (+/−2 g/m²);

Power type cathode coating thickness: 110 g/m² (+/−3 g/m²); and

Power type anode coating thickness: 52 g/m² (+/−2 g/m²).

As is known, a conventional lithium ion cell includes electrodes having a typical physical structure for each of a power cell and an energy cell. For example, the power cell electrode typically has more conductive tabs than does an energy cell electrode. For example, the tab count for each of a conventional power cell and an energy cell may be:

Energy type Cathode tabs: 3;

Energy type Anode tabs: 2;

Power type Cathode tabs: 5; and

Power type Anode tabs: 3.

In accordance with the invention, an optimized lithium ion battery cell is provided. The optimized lithium ion battery cell is preferably a lithium iron phosphate (LiFePO₄), or LFP, battery cell, which uses LiFePO₄ as a cathode material.

As described in Table 1, above, the optimized lithium ion battery cell of the present invention may include a cathode incorporating a cathode coating comprising the cathode powder and cathode mixing formula typically utilized in an energy cell. The optimized lithium ion battery cell of the present invention may include an anode incorporating an anode coating comprising the anode powder typically utilized in an energy cell and an anode mixing formula typically utilized in a power cell.

The optimized lithium ion battery cell may incorporate an anode and cathode coating thickness in between the typical coating thickness of a conventional power cell and a conventional energy cell. For example, the cathode coating thickness may be 145 g/m² (+/−3 g/m²), and the anode coating thickness may be 62 g/m² (+/−2 g/m²).

Further the optimized lithium ion battery cell may incorporate an anode and cathode electrode having a length in between the typical electrode length of a conventional power cell and a conventional energy cell. For example the optimized lithium ion battery cell may have a cathode electrode length of the order of 1670 mm (+/−0.5 mm), and an anode electrode length of the order of 1740 mm (+/−0.5 mm).

Still further, the optimized lithium ion battery cell may incorporate the electrode tab structure of a conventional power cell, which structure includes more tabs than would typically be found on a conventional energy cell. For example the optimized lithium ion battery cell may incorporate five tabs on cathode electrodes, and three tabs on anode electrodes. The cathode formula may be a ratio of Binder:Conductive agent:Active material=3:2:95. The anode formula may be a typical Power type anode formula ratio of Binder A:Conductive agent:Active material:Binder B=1.5:2:94:2.5. The cathode coating thickness may be 145 g/m² (+/−3 g/m²), and the anode coating thickness may be 62 g/m² (+/−2 g/m²).

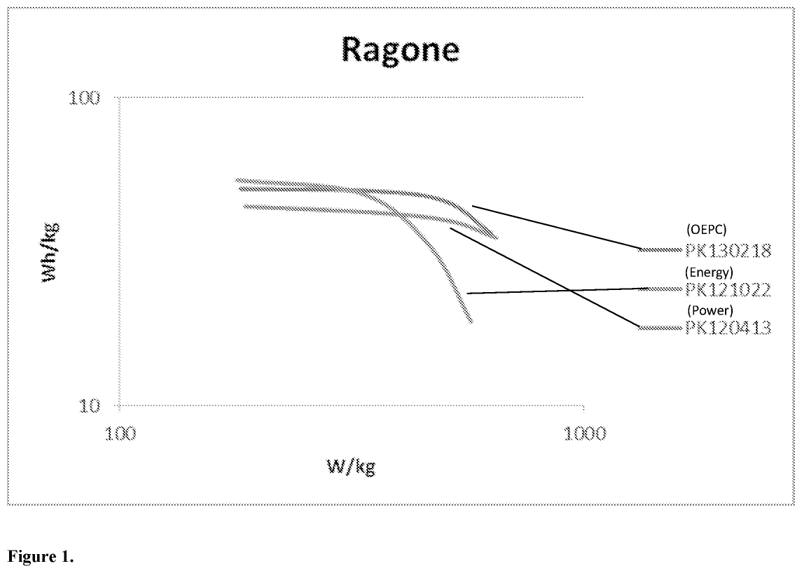

FIG. 1 is a Ragone plot of three cell types, a conventional 26650 power cell, a conventional 26650 energy cell and an optimized 26650 cell made in accordance with the present invention.

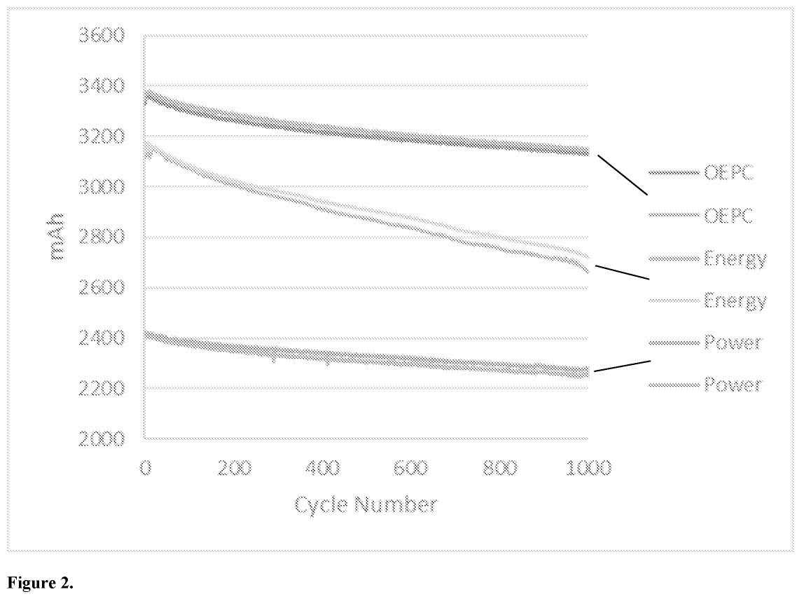

FIG. 2 is a life cycle comparison chart/graph of the three cell types (conventional power cell, conventional energy cell and optimized cell) at the same loading.

The two lines at the bottom illustrate conventional power type cells. The power cells start at a relatively lower capacity 2400 mAh, and after cycles (discharging and charging) for 1000 times, the power cells still have around 2300 mAh left in the cell. It fades out slowly.

The two lines in the middle illustrate conventional energy type cells. The energy cells start at a releatively high capacity at 3200 mAh, but they fade fast.

The two lines at the top illustrate optimized cells in accordance with the present invention. The optimized cells start at a relatively high capacity, and fade relatively more slowly.

It is to be understood that this disclosure is not intended to limit the invention to any particular form described, but to the contrary, the invention is intended to include all modifications, alternatives and equivalents falling within the spirit and scope of the invention.

We claim:

1. An optimized lithium ion battery cell comprising an anode and a cathode:
wherein the cathode is coated with a cathode coating comprising a cathode mixture of a cathode powder adapted for an energy cell application, a binder, and a conductive agent,
the cathode mixture being of a respective ratio of 3 (binder) to 2 (conductive agent) to 95 (cathode powder);
wherein the anode is coated with an anode coating comprising an anode mixture of an anode powder adapted for an energy cell application, a first binder, a second binder, and a conductive agent,
the anode mixture being of a respective ratio of 1.5 (first binder) to 2 (conductive agent) to 94 (anode powder) to 2.5 (second binder).

2. The battery cell of claim 1, wherein the cathode coating thickness is 145 g/m², +/−3 g/m².

3. The battery cell of claim 1, wherein the anode coating thickness is 62 g/m², +/−2 g/m².

4. The battery cell of claim 3, wherein the cathode coating thickness is 145 g/m², +/−3 g/m².

5. The battery cell of claim 1, wherein the cathode has a length of 1670 mm (+/−0.5 mm), and the anode has a length of 1740 mm (+/−0.5 mm).

6. The battery cell of claim 1, wherein the first binder of the anode mixture comprises a CMC (carboxymethyl cellulose) solution, and the second binder comprises styrene-butadiene rubber (SBR),
